(19) United States
(12) Patent Application Publication
(10) Pub. No.: US 2022/0286201 A1
(43) Pub. Date: Sep. 8, 2022

(54) DETECTION OF AMBIENT DISTURBANCES USING DISPERSIVE DELAYS IN OPTICAL FIBERS

(71) Applicant: Nokia Solutions and Networks OY, Espoo (FI)

(72) Inventors: Mikael Mazur, Summit, NJ (US); Nicolas Fontaine, New Providence, NJ (US)

(73) Assignee: Nokia Solutions and Networks OY, Espoo (FI)

(21) Appl. No.: 17/580,202

(22) Filed: Jan. 20, 2022

Related U.S. Application Data
(60) Provisional application No. 63/156,469, filed on Mar. 4, 2021.

(51) Int. Cl. H04B 10/07

(52) U.S. Cl. CPC H04B 10/07

(57) ABSTRACT

A fiber-optic communication system having two optical channels characterized by different respective group velocities. In an example embodiment, the system comprises an optical receiver capable of measuring a difference in the time of arrival thereto, by way of the two optical channels, of the corresponding signal disturbances caused by a remote ambient event, such as an earthquake or a lightning strike. A signal processor of the receiver can then use the measured time-of-arrival difference to estimate the distance, along the fiber, to the location of the remote ambient event. In some example embodiments, the two optical channels may be different wavelength channels or different spatial modes of a multimode fiber. In some example embodiments, at least one of the two channels may be a payload-data-bearing channel.

### CROSS-REFERENCE TO RELATED APPLICATIONS

This application claims the benefit of U.S. Provisional Patent Application No. 63/156,469, filed 4 Mar. 2021, and entitled “DETECTION OF AMBIENT DISTURBANCES USING DISPERSIVE DELAYS IN OPTICAL FIBERS,” which is incorporated herein by reference in its entirety.

### BACKGROUND

### Field

Various example embodiments relate to environmental sensing and, more specifically but not exclusively, to detection of ambient disturbances using terrestrial and/or submarine optical fibers.

### Description of the Related Art

This section introduces aspects that may help facilitate a better understanding of the disclosure. Accordingly, the statements of this section are to be read in this light and are not to be understood as admissions about what is in the prior art or what is not in the prior art.

There is an increased interest among network operators in the use of fiber-optic cables as distributed environmental sensors. Such sensors can be used, e.g., to detect some ambient disturbances, such as earthquakes, naturally occurring or man-induced mechanical vibrations, lightning strikes, etc.

### SUMMARY OF SOME SPECIFIC EMBODIMENTS

Disclosed herein are various embodiments of a fiber-optic communication system having two optical channels characterized by different respective group velocities. In an example embodiment, the system comprises an optical receiver capable of measuring a difference in the time of arrival thereto, by way of the two optical channels, of the corresponding signal disturbances caused by a remote ambient event, such as an earthquake or a lightning strike. A signal processor of the receiver can then use the measured time-of-arrival difference to estimate the distance, along the fiber, to the location of the remote ambient event. In some example embodiments, the two optical channels may be different wavelength channels or different spatial modes of a multimode fiber. In some example embodiments, at least one of the two channels may be a payload-data-bearing channel.

According to an example embodiment, provided is an apparatus, comprising: a first optical receiver configured to optically connect to an end segment of an optical fiber to perform a temporal sequence of measurements of a first optical signal received therefrom, the first optical signal having a first carrier wavelength; and a second optical receiver configured to optically connect to the end segment of the optical fiber to perform a temporal sequence of measurements of a second optical signal received therefrom, the second optical signal having a different second carrier wavelength; and wherein, from the measurements, the apparatus is configured to estimate a location of an ambient event based on a difference between receipt times of respective disturbed temporal segments of the first and second optical signals.

According to another example embodiment, provided is a method of environmental sensing, comprising the steps of: performing a temporal sequence of measurements of a first optical signal received by a first optical receiver from an end segment of an optical fiber, the first optical signal having a first carrier wavelength; performing a temporal sequence of measurements of a second optical signal received by a second optical receiver from the end segment of the optical fiber, the second optical signal having a different second carrier wavelength; and estimating a location of an ambient event based on a difference between receipt times of respective disturbed temporal segments of the first and second optical signals.

According to yet another example embodiment, provided is an apparatus, comprising: a first optical receiver configured to optically connect to an end segment of a multimode optical fiber to perform a temporal sequence of measurements of a first optical signal received therefrom, the first optical signal corresponding to a first spatial mode of the multimode optical fiber; and a second optical receiver configured to optically connect to the end segment of the optical fiber to perform a temporal sequence of measurements of a second optical signal received therefrom, the second optical signal corresponding to a different second spatial mode of the multimode optical fiber; and wherein, from the measurements, the apparatus is configured to estimate a location of an ambient event based on a difference between receipt times of respective disturbed temporal segments of the first and second optical signals.

In some embodiments of the above apparatus, the difference is caused, at least in part, by effects of modal dispersion in the multimode optical fiber.

According to yet another example embodiment, provided is an apparatus, comprising: a first optical receiver configured to optically connect to an end segment of a first optical fiber of a fiber-optic cable to perform a temporal sequence of measurements of a first optical signal received therefrom; and a second optical receiver configured to optically connect to an end segment of a different second optical fiber of the fiber-optic cable to perform a temporal sequence of measurements of a second optical signal received therefrom; and wherein, from the measurements, the apparatus is configured to estimate a location of an ambient event based on a difference between receipt times of respective disturbed temporal segments of the first and second optical signals.

In some embodiments of the above apparatus, the difference is caused, at least in part, by different group velocities of the first and second optical signals in the first and second optical fibers.

According to yet another example embodiment, provided is an apparatus, comprising: a first optical receiver configured to optically connect to an end segment of a first optical core of a multi-core optical fiber to perform a temporal sequence of measurements of a first optical signal received therefrom; and a second optical receiver configured to optically connect to an end segment of a different second optical core of the multi-core optical fiber to perform a temporal sequence of measurements of a second optical signal received therefrom; and wherein, from the measurements, the apparatus is configured to estimate a location of an ambient event based on a difference between receipt times of respective disturbed temporal segments of the first and second optical signals.

In some embodiments of the above apparatus, the difference is caused, at least in part, by different group velocities of the first and second optical signals in the first and second optical cores.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 graphically shows an example of optical-phase changes imparted by an earthquake onto an optical signal propagating through an optical fiber;

FIG. 2 graphically shows an example of state-of-polarization (SOP) changes imparted by a proximate lightning strike onto an optical signal propagating through an optical fiber;

FIG. 3 shows a graphical representation of an SOP using the Poincare sphere;

FIG. 4 shows a block diagram of an optical communication system in which at least some embodiments can be practiced;

FIG. 5 shows a block diagram of an optical data receiver that can be used in the optical communication system of FIG. 4 according to an embodiment;

FIG. 6 graphically shows an example WDM-channel configuration that can be used in the optical communication system of FIG. 4 according to an embodiment;

FIGS. 7A-7B graphically show qualitative time dependence of a signal characteristic for selected wavelength channels of the WDM-channel configuration of FIG. 6 according to an embodiment; and

FIG. 8 shows a flowchart of a method of mapping ambient events that can be used in the optical communication system of FIG. 4 according to an embodiment.

### DETAILED DESCRIPTION

Some conventional optical communications systems adapted for some of the above-indicated purposes may rely on bidirectional transmission of optical signals through an optical fiber and/or on loopback optical-path configurations. In some of such systems, precise clock synchronization between optical transmitters and/or receivers located at opposite ends of the optical fiber (e.g., separated by a distance on the order of 100 km, 1000 km, or even 10000 km) may be required. In some cases, such clock synchronization may not be available or may be difficult to achieve. A loopback configuration may be particularly challenging for long-haul submarine cables, e.g., because such a configuration effectively doubles the transmission distance, thereby significantly increasing the adverse effects of cumulative amplifier noise and/or some other transmission impairments.

At least some of these and possibly some other related problems in the state of the art can be addressed using at least some embodiments disclosed herein below.

An example embodiment can beneficially be implemented at a relatively small additional cost, with only small modifications of some of the network's wavelength-division-multiplexing (WDM) optical receivers, and without any modifications of the existing fiber-optic-cable plant.

Some embodiments may benefit from the use of apparatus, methods, and/or some features disclosed in commonly owned U.S. patent application Ser. No. 16/988,874, entitled “RAPID POLARIZATION TRACKING IN AN OPTICAL CHANNEL,” filed on 10 Aug. 2020, which is incorporated herein by reference in its entirety.

Some embodiments may benefit from the use of apparatus, methods, and/or some features disclosed in commonly owned U.S. patent application Ser. No. 17/108,057, entitled “DETECTION OF SEISMIC DISTURBANCES USING OPTICAL FIBERS,” filed on 1 Dec. 2020, which is incorporated herein by reference in its entirety.

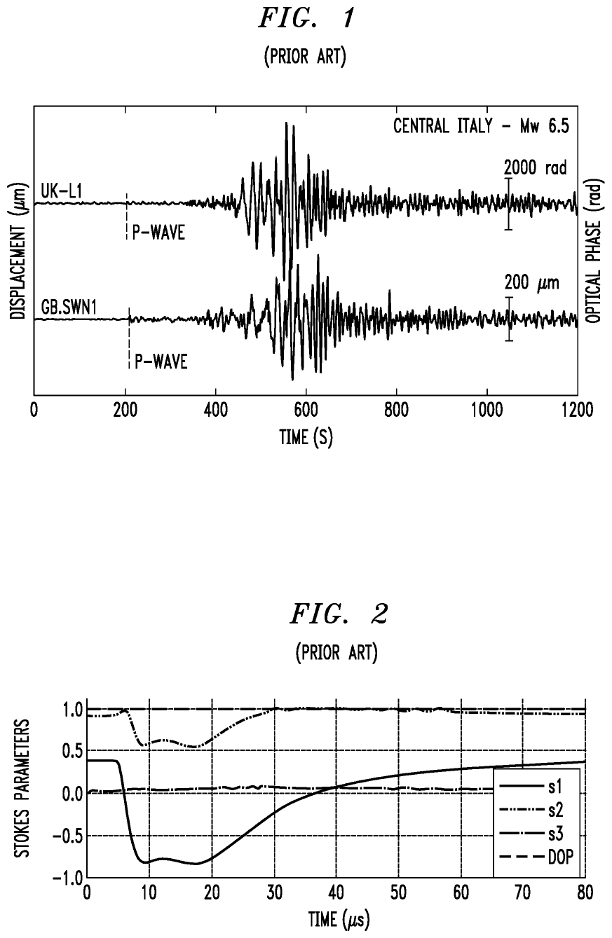

FIG. 1 graphically shows an example of optical-phase changes imparted by an earthquake onto an optical signal propagating through an optical fiber. This example is published, as FIG. 2A, in G. Marra, et al., Science 361, pp. 486-490 (2018), 3 Aug. 2018, which is incorporated herein by reference in its entirety. Earthquake-induced optical-phase changes on the order of 1000 radian are evident in the top trace shown in FIG. 1.

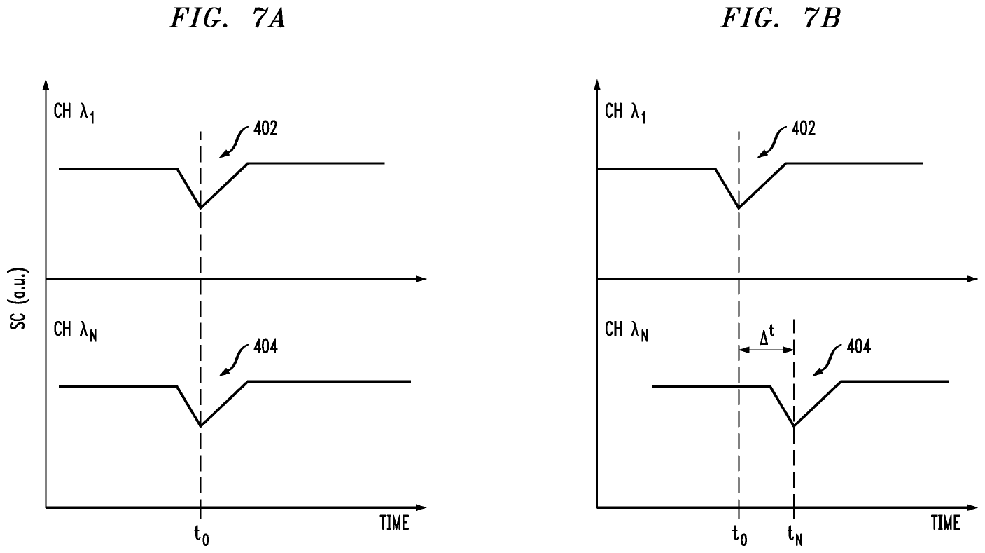

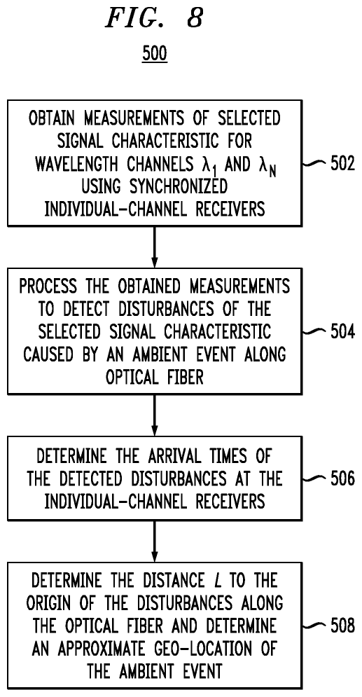

FIG. 2 graphically shows an example of state-of-polarization (SOP) changes imparted by a proximate lightning strike onto an optical signal propagating through an optical fiber. This example is published, as FIG. 7A, in P. Kummrich et al., “Demanding response time requirements on coherent receivers due to fast polarization rotations caused by lightning events,” Optics Express, Vol. 24, Issue 11, pp. 12442-12457 (2016), which is incorporated herein by reference in its entirety. Significant lightning-induced SOP changes are evident in FIG. 2.

In optics, polarized light can be represented by a Jones vector, and linear optical elements acting on the polarized light and mixtures thereof can be represented by Jones matrices. When light crosses such an optical element, the Jones vector of the output light can be found by taking a product of the Jones matrix of the optical element and the Jones vector of the input light, e.g., in accordance with Eq. (1):

$$[ \begin{matrix}{E}_{x}^{r} \\ {E}_{y}^{r}\end{matrix} ] = J ( θ , ϕ ) [ \begin{matrix}{E}_{x}^{t} \\ {E}_{y}^{t}\end{matrix} ] \qquad ( 1 )$$

where E^{t}ₓ and E^{t}_{y} are the x and y electric-field components, respectively, of the Jones vector of the input light; E^{r}ₓ, and E^{r}_{y} are the x and y electric-field components, respectively, of the Jones vector of the output light; and J(θ,ϕ) is the Jones matrix of the optical element given by Eq. (2):

$$J ( θ , ϕ ) = [ \begin{matrix}cos ( θ ) & - {e}^{- j ϕ} sin ( θ ) \\ {e}^{j ϕ} sin ( θ ) & cos ( θ )\end{matrix} ] \qquad ( 2 )$$

where 2θ and ϕ are the elevation and azimuth polarization rotation angles, respectively, the values of which can be used to define the SOP. For clarity, the above example of a Jones matrix does not include effects of optical attenuation and/or amplification. For example, in some cases, attenuation and/or amplification may be polarization-dependent.

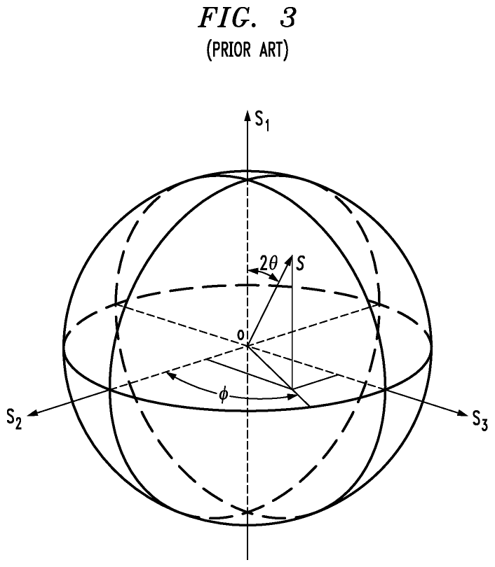

FIG. 3 shows a graphical representation of an SOP using the Poincare sphere. Herein, the Poincare sphere is a sphere of radius P centered on the origin of the three-dimensional Cartesian coordinate system, the mutually orthogonal axes S₁, S₂, and S₃ of which represent the corresponding Stokes parameters of the optical field. The radius P represents the optical power and is expressed by Eq. (3):

P=\sqrt{S₁²+S₂²+S₃²} (3)

For a given optical power P, different SOPs can be mapped to different respective points on the surface of the Poincare sphere. For example, the vector S shown in FIG. 3 represents one of such SOPs. An SOP rotation can then be visualized as a corresponding rotation of the vector S.

In some cases, it is convenient to use a unity-radius Poincare sphere, for which P=1. The unity-radius Poincare sphere can be obtained by normalizing the Stokes parameters with respect to the optical power P. For the unity-radius Poincare sphere, the angles θ and ϕ are related to the normalized Stokes parameters S₁′, S₂′, and S₃′ as follows:

$${S}_{1}^{′} = \frac{{S}_{1}}{P} = cos ( 2 θ ) \qquad ( 4 a )$$

$${S}_{2}^{′} = \frac{{S}_{2}}{P} = sin ( 2 θ ) cos ( ϕ ) \qquad ( 4 b )$$

$${S}_{3}^{′} = \frac{{S}_{3}}{P} = sin ( 2 θ ) cos ( ϕ ) \qquad ( 4 c )$$

As used herein, the term “polarization tracking” refers to time-resolved measurements of the SOP of an optical signal. In some embodiments, such polarization tracking may include determination, as a function of time, of the angles θ and ϕ. In some other embodiments, such polarization tracking may include determination, as a function of time, of the Stokes parameters S₁′, S₂′, and S₃′ of the normalized Stokes vector S′=(1 S₁'S₂′ S₃¹)^{T}, where the superscript T means transposed. In yet some other embodiments, such polarization tracking may include determination, as a function of time, of the Stokes parameters S₀=P, S₁, S₂, and S₃ of the non-normalized Stokes vector S=(S₀ S₁ S₂ S₃)^{T}. In some embodiments, suitable versions of Eqs. (1)-(4) may be used to program a digital signal processor (DSP) of an optical receiver to enable polarization tracking thereby.

Some embodiments may benefit from the use of alternatives to the above-outlined Stokes-vector formalism. Some of such alternatives, e.g., based on Jones matrices and/or Muller matrices are outlined, e.g., in M. Mazur and M. Karlsson, “Correlation Metric for Polarization Changes,” IEEE PHOTONICS TECHNOLOGY LETTERS, VOL. 30, NO. 17, pp. 1575-1578, Sep. 1, 2018, which is incorporated herein by reference in its entirety.

In optics, chromatic dispersion is the phenomenon due to which the phase velocity of an electromagnetic wave depends on the wave's frequency. In optical waveguides (e.g., optical fibers), chromatic dispersion may be caused both by the dispersive properties of the waveguide material(s) and by the waveguide geometry. In many practical systems, group velocity dispersion (GVD) is typically present. For example, when an optical signal (e.g., an optical pulse) has multiple frequency components therein, e.g., due to RF modulation of the optical carrier, the information carried by the optical signal only travels at the group-velocity rate even though some frequency components may be advancing at a faster rate (i.e., have a phase velocity greater than the group velocity). This effect typically causes a short pulse to be broadened, as different frequency components of the pulse travel at different velocities. In optical WDM, GVD also manifests itself in that different wavelength channels typically have different respective group velocities.

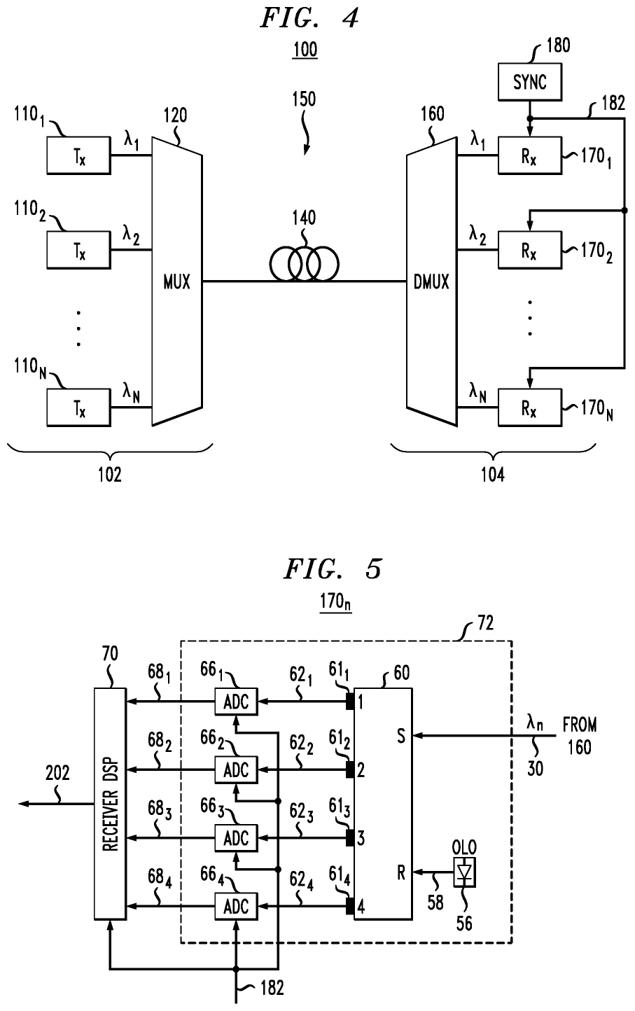

FIG. 4 shows a block diagram of an optical communication system 100 in which at least some embodiments can be practiced. System 100 comprises a wavelength-division-multiplexing (WDM) optical data transmitter 102 and a WDM optical data receiver 104 connected using a fiber-optic link 150. In an example embodiment, link 150 can be implemented using one or more all-optically end-connected spans of optical fiber 140. In addition, link 150 may optionally have one or more optical amplifiers (not explicitly shown in FIG. 4), e.g., each all-optically connected between ends of two respective spans of fiber 140. In some embodiments, link 150 may incorporate additional optical elements (not explicitly shown in FIG. 4), such as optical splitters, combiners, couplers, switches, etc., as known in the pertinent art. In some embodiments, link 150 may not have any optical amplifiers therein.

In an example embodiment, WDM optical data transmitter 102 and WDM optical data receiver 104 are configured to use two or more carrier wavelengths λ₁-λ_{N}. In some embodiments, system 100 can be configured to transport polarization-division-multiplexed (PDM) signals, wherein each of two orthogonal polarizations of each WDM optical channel can be individually modulated. In some such embodiments, each individual data symbol may have parts thereof on both of the two orthogonal polarizations.

In an example embodiment, WDM transmitter 102 comprises N individual optical data transmitters 110₁-110_{N}, where the number N is an integer greater than one. Each of optical data transmitters 110 uses a different respective carrier wavelength (e.g., one of wavelengths λ₁-λ_{N}, as indicated in FIG. 4) to generate a corresponding modulated optical signal. The individual optical data transmitters 110₁-110_{N} may be relatively local or remote. A local or spatially extended wavelength multiplexer (MUX) 120 may combine (multiplex) the different optical signals generated by optical data transmitters 110₁-110_{N}, thereby generating the corresponding WDM signal that is applied to link 150 for transmission to WDM optical data receiver 104.

In an example embodiment, WDM optical data receiver 104 comprises a local or spatially extended optical wavelength demultiplexer (DMUX) 160 and N individual optical data receivers 170₁-170_{N}. DMUX 160 operates to separate (demultiplex) the WDM components of the received optical WDM signal, thereby generating individual optical input signals of carrier wavelengths λ₁-λ_{N} for the optical data receivers 170₁-170_{N}, respectively.

WDM optical data receiver 104 further comprises a synchronization circuit (SYNC, e.g., a reference clock) 180 connected to provide a common clock signal 182 to some or all of the optical data receivers 170₁-170_{N}. For example, in some embodiments, clock signal 182 may be provided to just two of the optical data receivers 170, e.g., 170₁ and 170_{N}, while the remaining optical data receivers 170 may be independently clocked.

In some embodiments, two or more of the optical data receivers 170₁-170_{N} can be implemented in a single ASIC and clocked using that ASIC's clock circuit.

In some embodiments, synchronization circuit 180 may be external to WDM optical data receiver 104, e.g., can be a GPS clock source.

In some embodiments, synchronization circuit 180 may be absent, and different ones of the optical data receivers 170₁-170_{N} may be clocked using different respective clocks. In this case, a suitable calibration procedure may be used to measure the difference(s) between the different clocks, and then this information may be fed into the algorithm for determining the time-of-arrival difference Δt (also see FIGS. 7A-7B and the corresponding description below).

In some other embodiments, other alternative methods for providing a relative timing reference for different ones of the optical data receivers 170₁-170_{N} may be used. Some of such alternative methods may rely on GPS clocks, stable clocks, or stabilized system clocks or on locking the pertinent signals and/or devices to optical, microwave, or atomic clocks.

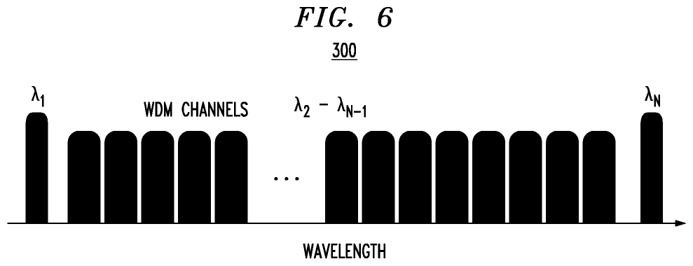

FIG. 5 shows a block diagram of an optical data receiver 170ₙ that can be used in system 100 (FIG. 4) according to an embodiment, where n=1, 2, . . . , N.

An optical front end (or O/E converter) 72 of receiver 170ₙ comprises an optical hybrid 60, light detectors 61₁-61₄, analog-to-digital converters (ADCs) 66₁-66₄, and an optical local-oscillator (OLO) source 56. Optical hybrid 60 has (i) two input ports labeled S and R and (ii) four output ports labeled 1 through 4. Input port S receives an optical signal 30 from wavelength DMUX 160. Input port R receives an OLO signal 58 generated by OLO source (e.g., laser) 56. OLO signal 58 has an optical-carrier wavelength (frequency) that is sufficiently close to that of optical signal 30 to enable coherent (e.g., intradyne) detection of the latter optical signal. ADCs 66₁-66₄ are clocked using clock signal 182 (also see FIG. 4).

In an example embodiment, optical hybrid 60 operates to mix optical signal 30 and OLO signal 58 to generate different mixed (e.g., by interference) optical signals (not explicitly shown in FIG. 5). Light detectors 61₁-61₄ then convert the mixed optical signals into four electrical signals 62₁-62₄ that are indicative of complex values corresponding to two orthogonal-polarization components of optical signal 30. For example, electrical signals 62₁ and 62₂ may be indicative of an analog I signal and an analog Q signal, respectively, or linearly independent mixtures thereof corresponding to a first (e.g., horizontal, h) polarization component of optical signal 30. Electrical signals 62₃ and 62₄ may similarly be indicative of an analog I signal and an analog Q signal, respectively, or linearly independent mixtures thereof corresponding to a second (e.g., vertical, v) polarization component of optical signal 30.

Each of electrical signals 62₁-62₄ is converted into digital form in a corresponding one of ADCs 66₁-66₄. Optionally, each of electrical signals 62₁-62₄ may be low-pass filtered and amplified in a corresponding electrical amplifier (not explicitly shown) prior to the resulting signal being converted into digital form. Digital signals 68₁-68₄ produced by ADCs 66₁-66₄, respectively, are then processed by a DSP 70 to recover a data stream 202 transmitted by transmitter 110ₙ. Digital signals 68₁-68₄ may further be processed in DSP 70, e.g., in accordance to method 500 (FIG. 8). In at least some embodiments, DSP 70 may receive a copy of clock signal 182.

In an example embodiment, DSP 70 may perform, inter alia, one or more of the following: (i) signal processing directed at dispersion compensation; (ii) signal processing directed at compensation of nonlinear distortions; (iii) electronic compensation for polarization rotation and polarization de-multiplexing; (iv) compensation of frequency offset between OLO 56 of optical receiver 170ₙ and laser source 20 of optical transmitter 110ₙ; (v) phase correction (vi) error correction based on the data encoding (if any) applied at transmitter 110ₙ; (vii) mapping of a set of complex values conveyed by digital signals 68₁-68₄ onto the operative constellation to determine a corresponding constellation symbol thereof and (vii) concatenating the binary labels (bit-words) of the constellation symbols determined through said mapping to generate an output data stream 202.

In some embodiments, one or more functions of DSP 70 can be performed by a larger DSP shared by different optical data receivers 170ₙ of system 100. In some embodiments, DSP 70 can be a part of such larger DSP.

In some alternative embodiments, optical data receiver 170ₙ may have a simplified structure, e.g., as outlined in the above-cited U.S. patent application Ser. No. 17/108,057 in reference to FIG. 4 thereof.

In some other alternative embodiments, optical data receiver 170ₙ may be a direct-detection receiver with a phase-detection capability.

FIG. 6 graphically shows an example WDM-channel configuration 300 that can be used in system 100 according to an embodiment. Configuration 300 has N wavelength channels denoted as λ₁-λ_{N}, wherein wavelength channels λ₂-λ_{N-1} have a larger spectral width than wavelength channels λ₁ and λ_{N}. For example, wavelength channels λ₂-λ_{N-1} can be used to transmit payload data modulated onto an optical carrier at a relatively high speed, and wavelength channels λ₁ and λ_{N} may be service, supervisory, or control channels.

As shown, wavelengths channels λ₁ and λ_{N} are spectrally located at the edges of the spectral range occupied by the payload-carrying wavelength channels λ₂-λ_{N-1}. However, embodiments are not so limited. For example, in some embodiments, carrier wavelengths λ₁ and λ_{N} can be smaller than any of carrier wavelengths λ₂-λ_{N-1}. In some other embodiments, both carrier wavelengths λ₁ and λ_{N} can be larger than any of carrier wavelengths λ₂-λ_{N-1}. In some embodiments, one or both of carrier wavelength λ₁ and λ_{N} can be can be spectrally located within the spectral range of wavelength channels λ₂-λ_{N-1}.

In an example embodiment, carrier wavelengths λ₁-λ_{N} can be selected in accordance with a frequency (wavelength) grid, such as a frequency grid that complies with the ITU-T G.694.1 Recommendation, which is incorporated herein by reference in its entirety. The frequency grid used in system 100 can be defined, e.g., in the frequency range from about 184 THz to about 201 THz, with a 100, 50, 25, or 12.5-GHz spacing of the channels therein. While typically defined in frequency units, the parameters of the grid can equivalently be expressed in wavelength units. For example, in the wavelength range from about 1528 nm to about 1568 nm, the 100-GHz spacing between the centers of neighboring WDM channels is equivalent to approximately 0.8-nm spacing. In alternative embodiments, other fixed or flexible (flex) frequency grids can be used as well.

In some alternative embodiments, wavelength channels λ₁ and λ_{N} can be of different type. For example, wavelength channel λ₁ can be a payload-data channel, and wavelength channel can be a supervisory channel. In some alternative embodiments, wavelength channels λ₁ and λ_{N} can both be payload-data channels. In some alternative embodiments, wavelength channels λ₁ and λ_{N} can carry unmodulated (e.g., CW) light.

FIGS. 7A-7B graphically show qualitative time dependence of a signal characteristic SC for wavelength channels λ₁ and λ_{N} of WDM-channel configuration 300 according to an embodiment. In some embodiments, signal characteristic SC can be an optical phase. In some other embodiments, signal characteristic SC can be a Stokes parameter. FIG. 7A shows the time dependence of signal characteristic SC at the location of a proximate ambient event, such as an incidence of a seismic wave or lightning strike, along fiber-optic link 150. FIG. 7B shows the time dependence of signal characteristic SC at WDM optical data receiver 104.

Referring to FIG. 7A, the above-mentioned ambient event may cause disturbances 402 and 404 in the signal characteristic SC of wavelength channels λ₁ and λ_{N}, respectively. Due to being caused by the same ambient event at the same location, SC disturbances 402 and 404 are initially time-aligned with one another approximately at time t₀ as indicated in FIG. 7A. For example, in some cases, each of SC disturbances 402 and 404 may be similar to the phase disturbance illustrated in FIG. 1. In some other cases, each of SC disturbances 402 and 404 may be, e.g., similar to the S₁ Stokes-parameter disturbance illustrated in FIG. 2.

Referring to FIG. 7B, the WDM components having SC disturbances 402 and 404 travel through fiber-optic link 150 toward WDM optical data receiver 104 at different respective group velocities corresponding to wavelength channels λ₁ and λ_{N}, respectively.

As a result, SC disturbances 402 and 404 arrive at WDM optical data receiver 104 at different respective times. More specifically, SC disturbance 402 arrives at optical data receiver 170₁ approximately at time t₁, whereas SC disturbance 404 arrives at optical data receiver 170_{N} approximately at time t_{N}. The time-of-arrival difference Δt=t_{N}−t₁ can be accurately measured because optical data receivers 170₁ and 170_{N} are clocked using the common clock signal 182, e.g., as indicated in FIGS. 4-5. Using the measured value of Δt and the group velocities corresponding to wavelength channels λ₁ and λ_{N}, the distance L along fiber-optic link 150 from WDM optical data receiver 104 to the location of the ambient event can be obtained in a straightforward manner. In some cases, Eq. (5) may provide a sufficiently accurate estimate of the distance L:

$$L = \frac{Δ t}{D \cdot \vert {λ}_{1} - {λ}_{N} \vert} \qquad ( 5 )$$

where D is the effective dispersion coefficient of fiber-optic link 150. Typically, dispersion coefficient D is expressed in the units of ps/(km·nm).

FIG. 8 shows a flowchart of a method 500 of mapping ambient events that can be used in system 100 according to an embodiment. In some embodiments, method 500 can advantageously be carried out based on the SC-disturbance measurements performed solely at WDM optical data receiver 104, and without relying on the event measurement(s) performed at any other network location(s).

At step 502 of method 500, optical data receivers 170₁ and 170_{N} are configured to obtain measurements of the signal characteristic SC for wavelength channels λ₁ and λ_{N}, respectively. Depending on the embodiment, the signal characteristic SC can be an optical phase, a selected Stokes parameter, etc. Such measurements of the signal characteristic SC can be obtained at each of optical data receivers 170₁ and 170_{N} based on the respective digital signals 68₁-68₄, e.g., as known in the pertinent art.

At step 504, the measurements of the signal characteristic SC obtained at step 502 may be processed to detect SC disturbances 402 and 404. In various embodiments, step 504 may be implemented using one or more processing sub-steps from the following non-exclusive list: (i) averaging the obtained measurements over overlapping or non-overlapping time windows; (ii) computing deviations of individual measurements from an average value; (iii) comparing the computed deviations with one or more threshold values; (iv) computing an envelope associated with a waveform represented by the measurements; (v) detecting an extremum of the envelope; (vi) computing a time derivative of the envelope; (vii) comparing the computed derivative with one or more threshold values; (viii) filtering a stream of measurements using a suitable digital filter; and (ix) applying a Fourier transform.

At step 506, the SC disturbances 402 and 404 detected at step 504 are processed to determine the arrival times t₁ and t_{N} (also see FIG. 7B). In an example embodiment, the arrival times t₁ and t_{N} can be determined as the timing of the same identifiable feature in SC disturbances 402 and 404, respectively. In the example shown in FIG. 7B, the minima of the SC disturbances 402 and 404 are used to determine the arrival times t₁ and t_{N}, as indicated in FIG. 7B. In other embodiments, the identifiable feature can be, e.g., the onset time of the disturbance; the time at which the envelope of the disturbance has an extremum; or the time at which a filtered disturbance has an extremum. Note that the arrival times t₁ and t_{N} are determined at step 506 with respect to the same reference time, e.g., derived from the common clock signal 182.

At step 508, the distance L is computed using the arrival times t₁ and t_{N} determined at step 506. For example, in some embodiments, Eq. (5) can be used for this purpose. In other embodiments, other suitable analytical or digital functions can be used, as deemed appropriate by those skilled in the pertinent art. The computed distance L and geographic map of fiber-optic link 150 can then be used to determine an approximate geo-location of the ambient event that caused SC disturbances 402 and 404.

In one alternative embodiment, system 100 may be modified for space-division-multiplexing (SDM), e.g., as follows. A single-mode optical fiber 140 is replaced by a multimode optical fiber. Wavelength MUX 120 and wavelength DMUX 160 are replaced by a spatial-mode MUX and a spatial-mode DMUX, respectively, configured for SDM, e.g., to selectively couple light to/from different transverse modes or different linear combinations of transverse modes of multimode optical fiber 140. In such a modified system, the same carrier wavelength, e.g., may be used for optical signals transmitted between different corresponding pairs of optical transmitters 110ₙ and receivers 170ₙ.

In this particular alternative embodiment, the relative propagation delay for the disturbances 402, 404 illustrated in FIGS. 7A-7B may be caused by the effects of modal dispersion in the multimode optical fiber 140, as opposed to the effects of chromatic dispersion in the embodiments employing a single-mode optical fiber, as described above. Since the parameters of modal dispersion for the used optical fiber are also typically known to the system designer or operator, the receiver DSP can be programmed in a similarly straightforward manner to determine the distance L to the location of the ambient event from the time-of-arrival difference Δt corresponding to appropriately selected two different spatial modes of multimode optical fiber 140.

In another alternative embodiment, system 100 may employ a multi-core fiber 140, wherein different cores may be used for optical signals transmitted between different corresponding pairs of optical transmitters 110ₙ and receivers 170ₙ. In this particular embodiment, the relative propagation delay illustrated in FIGS. 7A-7B may be caused by different group velocities of the transmitted optical signals in different optical cores. The latter characteristic may be a result of different optical properties of the different cores, e.g., due to different materials used therefor, different sizes/geometries thereof, etc.

The latter embodiment lends itself to a further straightforward modification in which a fiber-optic cable is used, and the pertinent different cores belong to different fiber strands or different separate optical fibers within the same fiber-optic cable.

Based on the description provided herein, a person of ordinary skill in the pertinent art will be able to make and use the above-indicated alternative embodiments without any undue experimentation.

According to an example embodiment disclosed above, e.g., in the summary section and/or in reference to any one or any combination of some or all of FIGS. 1-8, provided is an apparatus, comprising: a first optical receiver (e.g., 170₁, FIG. 4) configured to optically connect to an end segment of an optical fiber (e.g., 140, FIG. 4) to perform a temporal sequence of measurements of a first optical signal received therefrom, the first optical signal having a first carrier wavelength (e.g., FIG. 4); and a second optical receiver (e.g., 170_{N}, FIG. 4) configured to optically connect to the end segment of the optical fiber to perform a temporal sequence of measurements of a second optical signal received therefrom, the second optical signal having a different second carrier wavelength (e.g., λ_{N}, FIG. 4); and wherein, from the measurements, the apparatus is configured to estimate (e.g., at 508, FIG. 8) a location of an ambient event based on a difference between receipt times (e.g., Δt, FIG. 7B) of respective disturbed temporal segments (e.g., 402, 404, FIG. 7B) of the first and second optical signals.

In some embodiments of the above apparatus, the first and second optical receivers are synchronized using a common clock signal (e.g., 182, FIG. 4).

In some embodiments of any of the above apparatus, the difference is caused, at least in part, by effects of chromatic dispersion in the optical fiber.

In some embodiments of any of the above apparatus, the ambient event is one of: arrival of a seismic wave at the location along the optical fiber; a lightning strike at the location along the optical fiber; and mechanical vibration at the location along the optical fiber.

In some embodiments of any of the above apparatus, the apparatus is configured to detect the disturbed temporal segments by identifying a disturbance of optical phases of the first and second optical signals (e.g., top trace, FIG. 1).

In some embodiments of any of the above apparatus, the apparatus is configured to detect the disturbed segments by identifying a disturbance of a polarization of the first and second optical signals (e.g., S₁, S₂, S₃, FIGS. 2-3).

In some embodiments of any of the above apparatus, at least one of the first and second optical receivers is a polarization-sensitive coherent optical receiver (e.g., 170ₙ, FIG. 5).

In some embodiments of any of the above apparatus, the apparatus further comprises an optical wavelength demultiplexer (e.g., 160, FIG. 4) connected between the end segment of the optical fiber and the first and second optical receivers.

In some embodiments of any of the above apparatus, the apparatus further comprises a plurality of third optical receivers (e.g., 170₂-170_{N-1}, FIG. 4) connected to the optical wavelength demultiplexer to receive therethrough, from the end segment of the optical fiber, respective data-modulated optical signals.

In some embodiments of any of the above apparatus, at least one of the respective data-modulated optical signals has a carrier wavelength (e.g., one of λ₂-λ_{N-1}, FIG. 6) spectrally located between the first and second carrier wavelengths.

In some embodiments of any of the above apparatus, the apparatus further comprises a synchronization circuit (e.g., 180, FIG. 4) configured to generate a common clock signal for synchronizing the first and second optical receivers.

In some embodiments of any of the above apparatus, the first and second optical receivers are synchronized using a GPS clock source.

In some embodiments of any of the above apparatus, the first optical receiver is configured to recover data encoded in the first optical signal.

In some embodiments of any of the above apparatus, the second optical receiver is configured to recover data encoded in the second optical signal.

In some embodiments of any of the above apparatus, the estimate does not rely on optical-signal measurements at another end of the optical fiber.

In some embodiments of any of the above apparatus, the apparatus further comprises a digital signal processor (e.g., 70, FIG. 5) configured to identify (e.g., at 504, FIG. 8) the respective disturbed temporal segments of the first and second optical signals by processing the measurements to obtain time-resolved estimates of a selected signal characteristic (e.g., SC, FIG. 7B) of the first and second optical signals.

According to another example embodiment disclosed above, e.g., in the summary section and/or in reference to any one or any combination of some or all of FIGS. 1-8, provided is a method of environmental sensing comprising the steps of: performing a temporal sequence of measurements of a first optical signal received by a first optical receiver (e.g., 170₁, FIG. 4) from an end segment of an optical fiber (e.g., 140, FIG. 4), the first optical signal having a first carrier wavelength (e.g., λ₁, FIG. 4); performing a temporal sequence of measurements of a second optical signal received by a second optical receiver (e.g., 170_{N}, FIG. 4) from the end segment of the optical fiber, the second optical signal having a different second carrier wavelength (e.g., λ_{N}, FIG. 4); and estimating (e.g., at 508, FIG. 8) a location of an ambient event based on a difference between receipt times (e.g., Δt, FIG. 7B) of respective disturbed temporal segments (e.g., 402, 404, FIG. 7B) of the first and second optical signals.

In some embodiments of the above method, the method further comprises synchronizing the first and second optical receivers using a common clock signal (e.g., 182, FIG. 4).

In some embodiments of any of the above methods, the method further comprises detecting the disturbed temporal segments by identifying a disturbance of optical phases of the first and second optical signals (e.g., top trace, FIG. 1).

In some embodiments of any of the above methods, the method further comprises detecting the disturbed segments by identifying a disturbance of a polarization of the first and second optical signals (e.g., S₁, S₂, S₃, FIGS. 2-3).

In some embodiments of any of the above methods, the method further comprises identifying (e.g., at 504, FIG. 8) the respective disturbed temporal segments of the first and second optical signals by processing the measurements to obtain time-resolved estimates of a selected signal characteristic (e.g., SC, FIG. 7B) of the first and second optical signals.

According to yet another example embodiment disclosed above, e.g., in the summary section and/or in reference to any one or any combination of some or all of FIGS. 1-8, provided is an apparatus, comprising: a first optical receiver (e.g., 170₁, FIG. 4) configured to optically connect to an end segment of a multimode optical fiber (e.g., 140, FIG. 4) to perform a temporal sequence of measurements of a first optical signal received therefrom, the first optical signal corresponding to a first spatial mode of the multimode optical fiber; and a second optical receiver (e.g., 170_{N}, FIG. 4) configured to optically connect to the end segment of the optical fiber to perform a temporal sequence of measurements of a second optical signal received therefrom, the second optical signal corresponding to a different second spatial mode of the multimode optical fiber; and wherein, from the measurements, the apparatus is configured to estimate (e.g., at 508, FIG. 8) a location of an ambient event based on a difference between receipt times (e.g., Δt, FIG. 7B) of respective disturbed temporal segments (e.g., 402, 404, FIG. 7B) of the first and second optical signals.

In some embodiments of the above apparatus, the difference is caused, at least in part, by effects of modal dispersion in the multimode optical fiber.

According to yet another example embodiment disclosed above, e.g., in the summary section and/or in reference to any one or any combination of some or all of FIGS. 1-8, provided is an apparatus, comprising: a first optical receiver configured to optically connect to an end segment of a first optical fiber of a fiber-optic cable to perform a temporal sequence of measurements of a first optical signal received therefrom; and a second optical receiver configured to optically connect to an end segment of a different second optical fiber of the fiber-optic cable to perform a temporal sequence of measurements of a second optical signal received therefrom; and wherein, from the measurements, the apparatus is configured to estimate a location of an ambient event based on a difference between receipt times of respective disturbed temporal segments of the first and second optical signals.

In some embodiments of the above apparatus, the difference is caused, at least in part, by different group velocities of the first and second optical signals in the first and second optical fibers.

According to yet another example embodiment disclosed above, e.g., in the summary section and/or in reference to any one or any combination of some or all of FIGS. 1-8, provided is an apparatus, comprising: a first optical receiver (e.g., 170₁, FIG. 4) configured to optically connect to an end segment of a first optical core of a multi-core optical fiber (e.g., 140, FIG. 4) to perform a temporal sequence of measurements of a first optical signal received therefrom; and a second optical receiver (e.g., 170_{N}, FIG. 4) configured to optically connect to an end segment of a different second optical core of the multi-core optical fiber to perform a temporal sequence of measurements of a second optical signal received therefrom; and wherein, from the measurements, the apparatus is configured to estimate (e.g., at 508, FIG. 8) a location of an ambient event based on a difference between receipt times (e.g., Δt, FIG. 7B) of respective disturbed temporal segments (e.g., 402, 404, FIG. 7B) of the first and second optical signals.

In some embodiments of the above apparatus, the difference is caused, at least in part, by different group velocities of the first and second optical signals in the first and second optical cores.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the term compatible means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The description and drawings merely illustrate the principles of the disclosure. It will thus be appreciated that those of ordinary skill in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“SUMMARY OF SOME SPECIFIC EMBODIMENTS” in this specification is intended to introduce some example embodiments, with additional embodiments being described in “DETAILED DESCRIPTION” and/or in reference to one or more drawings. “SUMMARY OF SOME SPECIFIC EMBODIMENTS” is not intended to identify essential elements or features of the claimed subject matter, nor is it intended to limit the scope of the claimed subject matter.

What is claimed is:

1. An apparatus, comprising:
a first optical receiver configured to optically connect to an end segment of an optical fiber to perform a temporal sequence of measurements of a first optical signal received therefrom, the first optical signal having a first carrier wavelength; and
a second optical receiver configured to optically connect to the end segment of the optical fiber to perform a temporal sequence of measurements of a second optical signal received therefrom, the second optical signal having a different second carrier wavelength; and
wherein, from the measurements, the apparatus is configured to estimate a location of an ambient event based on a difference between receipt times of respective disturbed temporal segments of the first and second optical signals.

2. The apparatus of claim 1, wherein the first and second optical receivers are synchronized using a common clock signal.

3. The apparatus of claim 1, wherein the difference is caused, at least in part, by effects of chromatic dispersion in the optical fiber.

4. The apparatus of claim 1, wherein the ambient event is one of:
arrival of a seismic wave at the location along the optical fiber;
a lightning strike at the location along the optical fiber; and
mechanical vibration at the location along the optical fiber.

5. The apparatus of claim 1, wherein the apparatus is configured to detect the disturbed temporal segments by identifying a disturbance of optical phases of the first and second optical signals.

6. The apparatus of claim 1, wherein the apparatus is configured to detect the disturbed segments by identifying a disturbance of a polarization of the first and second optical signals.

7. The apparatus of claim 1, wherein at least one of the first and second optical receivers is a polarization-sensitive coherent optical receiver.

8. The apparatus of claim 1, further comprising an optical wavelength demultiplexer connected between the end segment of the optical fiber and the first and second optical receivers.

9. The apparatus of claim 8, further comprising a plurality of third optical receivers connected to the optical wavelength demultiplexer to receive therethrough, from the end segment of the optical fiber, respective data-modulated optical signals.

10. The apparatus of claim 1, further comprising a synchronization circuit configured to generate a common clock signal for synchronizing the first and second optical receivers.

11. The apparatus of claim 1, wherein the first and second optical receivers are synchronized using a GPS clock source.

12. The apparatus of claim 1, wherein the first optical receiver is configured to recover data encoded in the first optical signal.

13. The apparatus of claim 12, wherein the second optical receiver is configured to recover data encoded in the second optical signal.

14. The apparatus of claim 1, wherein the estimate does not rely on optical-signal measurements at another end of the optical fiber.

15. The apparatus of claim 1, further comprising a digital signal processor configured to identify the respective disturbed temporal segments of the first and second optical signals by processing the measurements to obtain time-resolved estimates of a selected signal characteristic of the first and second optical signals.

16. A method of environmental sensing, comprising:
performing a temporal sequence of measurements of a first optical signal received by a first optical receiver from an end segment of an optical fiber, the first optical signal having a first carrier wavelength;
performing a temporal sequence of measurements of a second optical signal received by a second optical receiver from the end segment of the optical fiber, the second optical signal having a different second carrier wavelength; and
estimating a location of an ambient event based on a difference between receipt times of respective disturbed temporal segments of the first and second optical signals.

17. The method of claim 16, further comprising synchronizing the first and second optical receivers using a common clock signal.

18. The method of claim 16, further comprising detecting the disturbed temporal segments by identifying a disturbance of optical phases of the first and second optical signals.

19. The method of claim 16, further comprising detecting the disturbed segments by identifying a disturbance of a polarization of the first and second optical signals.

20. The method of claim 16, further comprising identifying the respective disturbed temporal segments of the first and second optical signals by processing the measurements to obtain time-resolved estimates of a selected signal characteristic of the first and second optical signals.
